(19) United States
(12) Patent Application Publication
(10) Pub. No.: US 2016/0039199 A1
(43) Pub. Date: Feb. 11, 2016

(54) INK JET HEAD AND IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventors: Teruyuki Hiyoshi, Izunokuni (JP); Noboru Nitta, Kannami Tagata (JP); Shunichi Ono, Izu (JP)

(21) Appl. No.: 14/814,843

(22) Filed: Jul. 31, 2015

(30) Foreign Application Priority Data
Aug. 5, 2014 (JP) 2014-159635

(51) Int. Cl. B41J 2/045

(52) U.S. Cl. CPC B41J 2/04536; B41J 2/04588; B41J 2/04581

(57) ABSTRACT

According to one embodiment, an ink jet head includes: a plurality of nozzles that eject ink drops; an image storage unit that stores image data; an adjustment storage unit that stores adjustment data which is set for each nozzle in order to uniformly correct variations in ink drops ejected from a plurality of nozzles; and a setting storage unit that stores setting data for changing an adjustment range using the adjustment data. The inkjet head converts the adjustment data into adjustment effective data which is obtained by changing the adjustment range using the adjustment data on the basis of the setting data. The ink jet head generates a driving pulse waveform which is obtained by adjusting a reference pulse waveform of a driving pulse signal by using the adjustment effective data on the basis of the image data for each nozzle.

### CROSS-REFERENCE TO RELATED APPLICATION

This application is based upon and claims the benefit of priority from Japanese Patent Application No. 2014-159635, filed Aug. 5, 2014, the entire contents of which are incorporated herein by reference.

### FIELD

An exemplary embodiment described herein relates generally to an ink jet head and an image forming apparatus using the head.

### BACKGROUND

An ink jet head has a configuration in which a plurality of pressure chambers filled with ink are disposed in parallel to each other so as to be partitioned by sidewalls formed of a piezoelectric member, and a nozzle for ejecting ink drops is provided in each pressure chamber. A variation occurs in an ejection volume of ink drops which are ejected from each nozzle due to a variation in dimensional accuracy of components or assembly accuracy in a manufacturing process of the ink jet head. As a technique for reducing the variation in the ejection volume, in the related art, there is a technique of adjusting conduction time of an increase pulse for conducting a piezoelectric member in order to change the shape of a pressure chamber from a steady state to a state in which the volume thereof is increased.

However, a variation in the ejection volume of ink drops also occurs due to characteristics of ink to be used. For this reason, there is a need to adjust conduction time of an increase pulse so as to also handle a variation caused by ink characteristics.

### DESCRIPTION OF THE DRAWINGS

FIG. 1 is a partially exploded perspective view illustrating an ink jet head.

FIG. 2 is a cross-sectional view of a front portion.

FIG. 3 is a longitudinal sectional view.

FIGS. 4A to 4C are schematic diagrams for explaining an operation principle.

FIG. 5 is a block diagram illustrating a hardware configuration of an ink jet printer.

FIG. 6 is a block diagram illustrating a specific configuration of a head driver.

FIG. 7 is a timing diagram illustrating various signal waveforms related to the head driver.

FIG. 8 is a block diagram illustrating details of a driving waveform generation circuit and relationships with peripheral circuits thereof.

FIG. 9 is a block diagram illustrating details of a configuration of a conversion circuit.

FIG. 10 is a timing diagram illustrating various signal waveforms related to an adjusting circuit.

FIG. 11 is a diagram illustrating that a value of adjustment effective data calculated by a conversion circuit is correlated with an adjustment range and a resolution.

FIG. 12(a) to FIG. 12(e) are timing diagrams illustrating examples of driving pulse signals obtained when adjustment effective data items are different from each other.

FIG. 13 is a diagram illustrating graphs each of which shows an extent of change in an ink ejection volume for an adjustment time period when seven ink drops are ejected.

FIG. 14 is a diagram illustrating graphs each of which shows an extent of change in an ink ejection volume for an adjustment time period when a single ink drop is ejected.

### DETAILED DESCRIPTION

An object of an exemplary embodiment is to provide an ink jet head in which a variation in an ejection volume of ink drops ejected from each nozzle can be flexibly adjusted, and an image forming apparatus using the ink jet head.

According to an exemplary embodiment, an ink jet head includes a plurality of nozzles that eject ink drops through operations of corresponding driving elements; an image storage unit; an adjustment storage unit; a setting storage unit; a conversion unit; and a generation and output unit. The image storage unit stores image data. The adjustment storage unit stores adjustment data which is set for each nozzle in order to uniformly correct variations in the ink drops ejected from the plurality of nozzles. The setting storage unit stores setting data for changing an adjustment range using the adjustment data. The conversion unit converts the adjustment data into adjustment effective data which is obtained by changing the adjustment range using the adjustment data on the basis of the setting data. The generation and output unit generates a driving pulse waveform which is obtained by adjusting a reference pulse waveform of a driving pulse signal for operating the driving element by using the adjustment effective data on the basis of the image data for each nozzle. The generation and output unit applies the driving pulse signal with the driving pulse waveform to the driving element corresponding to each nozzle.

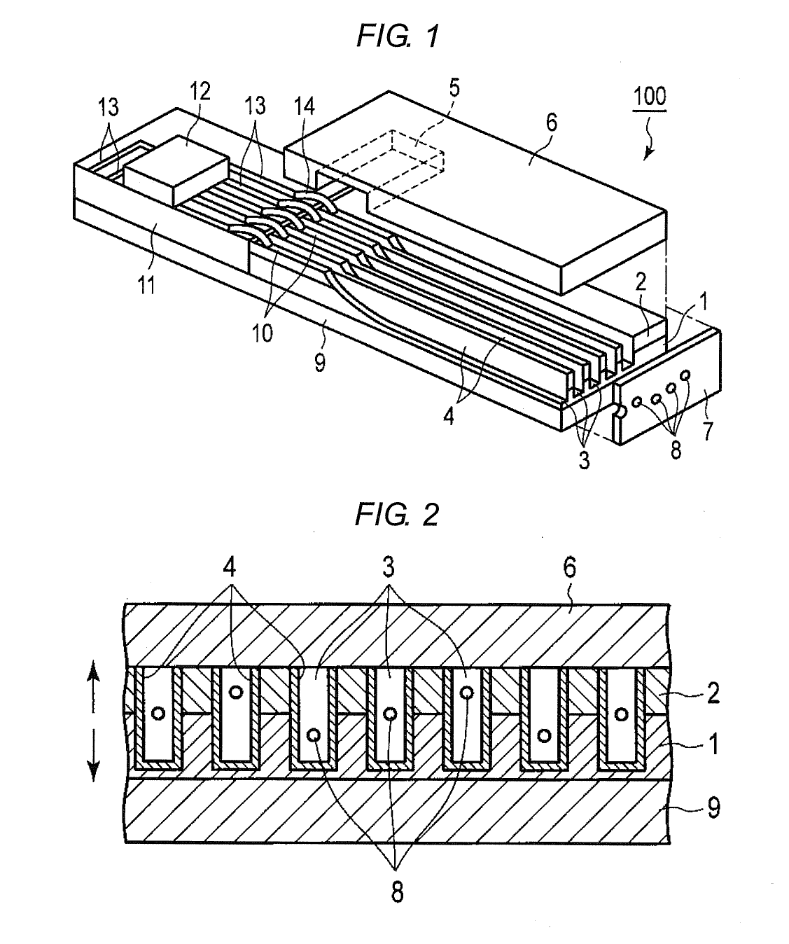

Hereinafter, with reference to the drawings, an inkjet head according to an exemplary embodiment and an image forming apparatus (ink jet printer) using the ink jet head will be described. In addition, in this exemplary embodiment, a share mode type ink jet head 100 (refer to FIG. 1) is exemplified as an ink jet head.

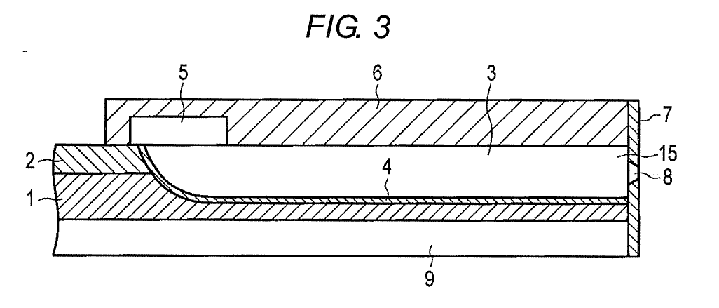

First, a description will be made of a configuration of the ink jet head 100 (hereinafter, simply referred to as the head 100) with reference to FIGS. 1 to 3. FIG. 1 is a partially exploded perspective view illustrating the head 100, FIG. 2 is a cross-sectional view of a front portion of the head 100, and FIG. 3 is a longitudinal sectional view of the front portion of the head 100.

The head 100 includes a base substrate 9. In the head 100, a first piezoelectric member 1 is joined to a front upper surface of the base substrate 9, and a second piezoelectric member 2 is joined onto the first piezoelectric member 1. The joined first piezoelectric member 1 and second piezoelectric member 2 are polarized in opposite directions to each other along a plate thickness direction as indicated by arrows shown in FIG. 2.

The base substrate 9 is formed by using a material which has a low dielectric constant and has a thermal expansion coefficient which is slightly different from those of the piezoelectric members 1 and 2. As materials of the base substrate 9, for example, alumina (Al₂O₃), silicon nitride (Si₃N₄), silicon carbide (SiC), aluminum nitride (AlN), and lead titanate zirconate (PZT) may be used. On the other hand, as materials of the piezoelectric members 1 and 2, lead titanate zirconate (PZT), lithium niobate (LiNbO₃), lithium tantalate (LiTaO₃), and the like are used.

The head 100 is provided with a plurality of long grooves 3 from the front end side of the joined piezoelectric members 1 and 2 toward the rear end side thereof. The grooves 3 are parallel to each other with a constant gap therebetween. Each of the grooves 3 has a front end which is open and a rear end which is tilted upwardly.

In the head 100, an electrode 4 is provided on a sidewall and a bottom of each groove 3. The electrode 4 has a two-layer structure of nickel (Ni) and gold (Au). The electrode 4 is uniformly formed inside each groove 3 by using, for example, a plating method. A method of forming the electrode 4 is not limited to the plating method. For example, a sputtering method or a deposition method may be used.

In the head 100, an extraction electrode 10 is provided from the rear end of each groove 3 toward the rear upper surface of the second piezoelectric member 2. The extraction electrode 10 extends from the electrode 4.

The head 100 includes a top plate 6 and an orifice plate 7. The top plate 6 closes the upper parts of the grooves 3. The orifice plate 7 closes the front ends of the grooves 3. In the head 100, a plurality of pressure chambers 15 are formed by the grooves 3 surrounded by the top plate 6 and the orifice plate 7. Each of the pressure chambers 15 has a shape which is, for example, 300 μm deep and 80 μm wide, and the pressure chambers 15 are arranged in parallel to each other with a pitch of 169 μm. The pressure chamber 15 is also referred to as an ink chamber.

The top plate 6 is provided with a common ink chamber 5 rearward to the inside thereof. The orifice plate 7 is provided with nozzles 8 at positions facing the respective grooves 3. Each nozzle 8 communicates with the opposing groove 3, that is, the pressure chamber 15. The nozzle 8 has a shape which is tapered from the pressure chamber 15 side toward the ink ejection side on an opposite side thereto. The nozzles 8 corresponding to three pressure chambers 15 adjacent to each other form a set, and are deviated relative to each other at constant intervals in a height direction of the groove 3 (a vertical direction in FIG. 2).

In the head 100, a printed board 11 on which a conductive pattern 13 is formed is joined to the rear upper surface of the base substrate 9. In the head 100, a drive IC 12 including a head driver 101 which will be described later is mounted on the printed board 11. The drive IC 12 is connected to the conductive pattern 13. The conductive pattern 13 is coupled to each extraction electrode 10 via a lead wire 14 via wire bonding.

A set of the pressure chamber 15, the electrode 4, and the nozzle 8 of the head 100 is referred to as a channel. In other words, the head 100 includes the channels ch.1, ch.2, . . . , and ch.N corresponding to the number N of grooves 3.

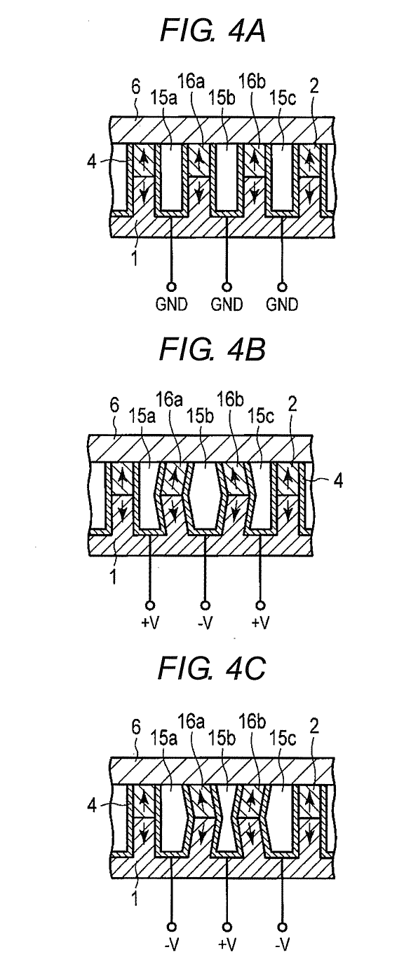

Next, a description will be made of an operation principle of the head 100 with the above-described configuration with reference to FIGS. 4A to 4C.

FIG. 4A illustrates a state in which the electrodes 4 which are respectively disposed on wall surfaces between a central pressure chamber 15b and both pressure chambers 15a and 15c adjacent to the pressure chamber 15b all have a ground potential GND. In this state, a partition 16a interposed between the pressure chamber 15a and the pressure chamber 15b and a partition 16b interposed between the pressure chamber 15b and the pressure chamber 15c, do not receive any distortion.

FIG. 4B illustrates a state in which a negative voltage −V is applied to the electrode 4 of the central pressure chamber 15b, and a positive voltage +V is applied to the electrodes 4 of both the adjacent pressure chambers 15a and 15c. In this state, an electric field which is twice as large as the voltage V is applied to the respective partitions 16a and 16b in a direction perpendicular to a polarization direction of the piezoelectric members 1 and 2. Due to this application, the respective partitions 16a and 16b are deformed outward so as to increase a volume of the pressure chamber 15b.

FIG. 4C illustrates a state in which the positive voltage +V is applied to the electrode 4 of the central pressure chamber 15b, and the negative voltage −V is applied to the electrodes 4 of both the adjacent pressure chambers 15a and 15c. In this state, an electric field which is twice as large as the voltage V is applied to the respective partitions 16a and 16b in an opposite direction to the case of FIG. 4B. Due to this application, the respective partitions 16a and 16b are deformed inward so as to decrease a volume of the pressure chamber 15b.

If a volume of the pressure chamber 15b is increased or decreased, pressure vibration occurs in the pressure chamber 15b. Due to this pressure vibration, a pressure in the pressure chamber 15b increases, and thus ink drops are ejected from the nozzle 8 which communicates with the pressure chamber 15b.

As mentioned above, the partitions 16a and 16b which separate the respective pressure chambers 15a, 15b and 15c from each other are actuators for giving pressure vibration to the inside of the pressure chamber 15b which has the-partitions 16a and 16b as wall surfaces. Therefore, each pressure chamber 15 shares the actuator with the respectively adjacent pressure chambers 15. For this reason, the head driver 101 cannot drive each pressure chamber 15 individually. The head driver 101 divides the respective pressure chambers 15 into (n+1) groups at intervals of n (where n is an integer of 2 or more) for driving.

In the present exemplary embodiment, the number of channels of the head 100 is assumed to be “324”. Therefore, the number of nozzles 8 is also “324”. In the present exemplary embodiment, nozzle numbers such as N1, N2, N3, . . . , and N324 are sequentially added to the 324 nozzles 8 from one end of the head 100 to the other end thereof. On the other hand, the head driver 101 performs so-called three-division driving in which the channels ch.1 to ch.324 are divided into three phases including an A phase, a B phase, and a C phase at intervals of two and are driven. In other words, when the ch.1, ch.4, . . . , and ch.322 included in the A phase are driven, the nozzles 8 whose nozzle numbers are N1, N4, . . . , and N322 are ink ejection targets. When the ch.2, ch.5, . . . , and ch.323 included in the B phase are driven, the nozzles 8 whose nozzle numbers are N2, N5, and N323 are ink ejection targets. When the ch.3, ch.6, . . . , and ch.324 included in the C phase are driven, the nozzles 8 whose nozzle numbers are N3, N6, . . . , and N324 are ink ejection targets.

In the present exemplary embodiment, three channels adjacent to each other, included in the different phases, are referred to as a group G. Therefore, the channels ch.1 to ch.324 are divided into a total of 108 groups from a group G1 to a group G108. The head driver 101 first drives the channels ch.1, ch.4, . . . , and ch.322 included in the A phase of the groups G1 to G108. Next, the head driver 101 drives the channels ch.2, ch.5, . . . , and ch.323 included in the B phase. Next, the head driver 101 drives the channels ch.3, ch.6, . . . , and ch.324 included in the C phase. Subsequently, the head driver 101 drives the channels of the groups G1 to G108 in order of the A phase, the B phase, and the C phase.

Next, a description will be made of an image forming apparatus, a so-called ink jet printer 300 (hereinafter, simply referred to as a printer 300) which forms an image on a recording medium by ejecting ink from the head 100.

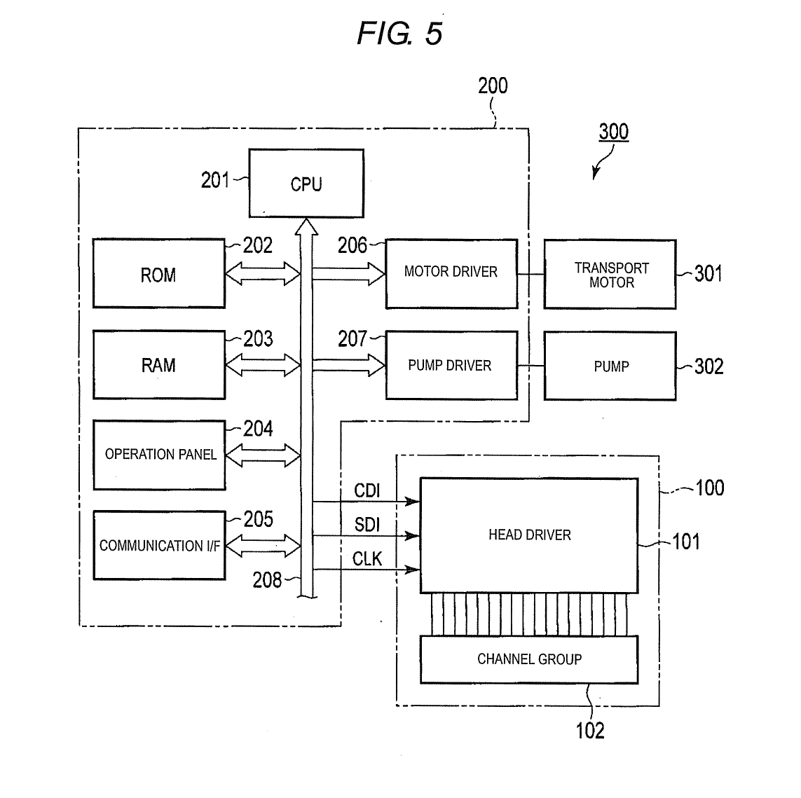

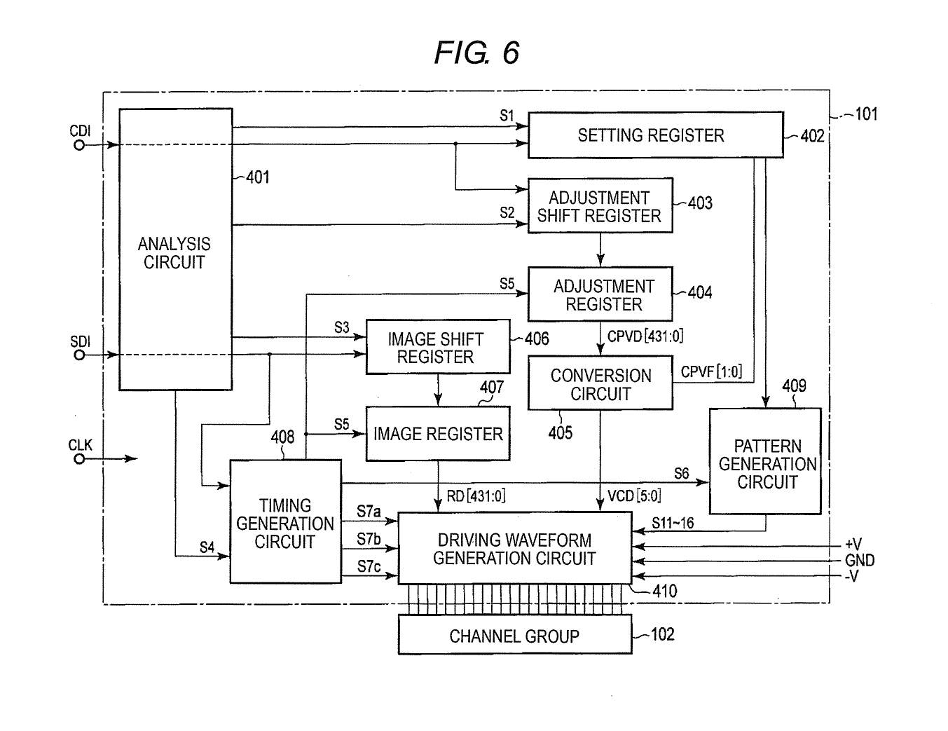

FIG. 5 is a block diagram illustrating a hardware configuration of the printer 300. The printer 300 includes the head 100, and a control board 200 which is a control section controlling the head 100. In the printer 300, a central processing unit (CPU) 201, a read only memory (ROM) 202, a random access memory (RAM) 203, an operation panel 204, a communication interface 205, a motor driver 206, a pump driver 207, and the like are mounted on the control board 200. In the printer 300, a bus line 208 such as an address bus and a data bus is disposed on the control board 200. In the printer 300, the CPU 201, the ROM 202, the RAM 203, the operation panel 204, the communication interface 205, the motor driver 206, the pump driver 207, and the like are connected to the bus line 208.

The CPU 201 corresponds to a core of a computer. The CPU 201 controls the respective units so as to perform various functions of the printer 300 according to an operating system or an application program.

The ROM 202 corresponds to a main storage portion of the computer. The ROM 202 stores the operating system or the application program. The ROM 202 may store data which is required for the CPU 201 to perform a process for controlling each unit.

The RAM 203 corresponds to a main storage portion of the computer. The RAM 203 stores data which is required for the CPU 201 to perform a process. The RAM 203 may be used as a work area in which information is appropriately rewritten by the CPU 201. The work area includes an image memory on which printing data is developed.

The operation panel 204 includes an operation unit and a display unit. The operation Unit includes function keys such as a power key, a paper feed key, and an error cancel key, disposed thereon. The display unit displays various states in the printer 300.

The communication interface 205 receives printing data from a client terminal which is connected thereto via a network such as a local area network (LAN). For example, if an error occurs in the printer 300, the communication interface 205 transmits a signal for a notification of the error to the client terminal.

The motor driver 206 controls driving of a transport motor 301. The transport motor 301 is a driving source of a transport mechanism which transports a recording medium such as printing paper. If the transport motor 301 is driven, the transport mechanism starts transport of a recording medium. The transport mechanism transports the recording medium to a position where the head 100 performs printing. The transport mechanism discharges the recording medium on which an image is formed, to the outside of the printer 300 from a predetermined discharge port.

The pump driver 207 controls driving of a pump 302. If the pump 302 is driven, ink inside an ink tank (not illustrated) is supplied to the head 100.

The head 100 includes the head driver 101 and a channel group 102. The channel group 102 indicates a group of the channels ch.1 to ch.324 each of which is formed of a set of the above-described pressure chamber 15, electrode 4 and nozzle 8.

The head driver 101 receives a command data in (CDI) signal, a serial data in (SDI) signal, and a clock (CLK) signal from the control board 200.

The CDI signal is an interface signal for supplying setting data and adjustment data from the control board 200 side to the head 100. The setting data is supplied to the head 100 at the beginning of a printing sequence. The adjustment data is supplied to the head 100 subsequently to the setting data.

The setting data includes pattern data and sensitivity data CPVF. The pattern data is data supplied in order to generate a waveform pattern of a driving pulse signal for driving each of the channels ch.1 to ch.324. The driving pulse signal includes an increase pulse which increases a volume of the pressure chamber 15 and a decrease pulse which decreases a volume of the pressure chamber 15. The sensitivity data CPVF will be described later.

The adjustment data adjusts On timing of the increase pulse forming the driving pulse signal. The adjustment data includes adjustment data (A phase adjustment data) used when the channels ch.1, ch.4, . . . , and ch.322 included in the A phase are driven, adjustment data (B phase adjustment data) used when the channels ch.2, ch.5, . . . , and ch.323 included in the B phase are driven, and adjustment data (C phase adjustment data) used when the channels ch.3, ch.6, . . . , and ch.324 included in the C phase are driven.

The SDI signal is an interface signal for supplying image data to the head 100. The image data designates the number of ink drops ejected from the nozzle 8 of each of the channels ch.1 to ch.324. The image data includes A phase image data for the nozzles 8 of the channels ch.1, ch.4, . . . , and ch.322 included in the A phase, B phase image data for the nozzles 8 of the channels ch.2, ch.5, . . . , and ch.323 included in the B phase, and C phase image data for the nozzles 8 of the channels ch.3, ch.6, . . . , and ch.324 included in the C phase.

The CLK signal is a reference clock of a logic circuit mounted in the head 100. The reference clock of the present exemplary embodiment is output at a frequency of 50 MHz. Therefore, a cycle of the reference clock is 20 nsec.

The head driver 101 drives the 324 channels ch.1 to ch.324 forming the channel group 102 in a three-division manner on the basis of the CDI signal, the SDI signal, and the CLK signal. Through such driving, ink drops are appropriately ejected from the nozzle 8 of each of the channels ch.1 to ch.324. The ink drops ejected from the nozzle 8 are landed on a printing surface of a recording medium which is transported through driving of the transport motor 301. As a result, a multi-value image is formed on the printing surface. A pressure chamber of the channel in which ink becomes insufficient due to the ejection of ink drops is replenished with the ink inside the ink tank through the driving of the pump 302.

FIG. 6 is a block diagram illustrating details of a configuration of the head driver 101. The head driver 101 includes an analysis circuit 401, a setting register 402, an adjustment shift register 403, an adjustment register 404, a conversion circuit 405, an image shift register 406, an image register 407, a timing generation circuit 408, a pattern generation circuit 409, and a driving waveform generation circuit 410. The circuits 401, 405, 408, 409 and 410 and the registers 402, 403, 404, 406 and 407 operate with the CLK signal as a reference clock.

The analysis circuit 401 analyzes a command received via the CDI signal or the SDI signal. If the command is a setting data recording command, the analysis circuit 401 outputs a permission signal S1 to the setting register 402. If the command is an adjustment data recording command, the analysis circuit 401 outputs a permission signal S2 to the adjustment shift register 403. If the command is an image data recording command, the analysis circuit 401 outputs a permission signal S3 to the image shift register 406. If the command is a recording command of the B phase image data of a first line, the analysis circuit 401 outputs a permission signal S4 to the timing generation circuit 408 (analysis and output unit).

In response to the input of the permission signal S1, the setting register 402 stores setting data received via the CDI signal (setting storage unit). In the present exemplary embodiment, the command uses 8 bits. The setting data uses 36 bytes. Therefore, serial data for the setting data, received via the CDI signal is formed of a leading 1-bit start bit, a subsequent 8-bit setting data recording command, and subsequent 288(=36×8)-bit setting data.

In response to the input of the permission signal S2, the adjustment shift register 403 stores adjustment data CPVD received via the CDI signal. In the present exemplary embodiment, the adjustment data CPVD uses four bits for every group from the group G1 to the group G108. In other words, the adjustment data is formed of data of a total of 432 bits including 4-bit adjustment data G1 CPVD for the group G1, 4-bit adjustment data G2_CPVD for the group G2, . . . , and 4-bit adjustment data G108 CPVD for the group G108. Therefore, serial data for the adjustment data, received via the CDI signal is formed of a leading 1-bit start bit, a subsequent 8-bit adjustment data recording command, and subsequent 432-bit adjustment data CPVD.

In response to the input of the permission signal S3, the image shift register 406 stores image data received via the SDI signal. In the present exemplary embodiment, the image data RD uses four bits for each of the group G1 to the group G108. In other words, the image data RD is formed of data of a total of 432 bits including 4-bit image data G1_RD for the group G1, 4-bit image data G2_RD for the group G2, . . . , and 4-bit image data G108_RD for the group G108. Therefore, serial data for the image data, received via the SDI signal is formed of a leading 1-bit start bit, a subsequent 8-bit image data recording command, and subsequent 432-bit image data RD.

In response to the input of the permission signal S4, the timing generation circuit 408 generates printing timing for driving the head 100 in such a three-division manner as in the A phase, the B phase, and the C phase. The timing generation circuit 408 outputs a data latch signal S5 to the adjustment register 404 and the image register 407 on the basis of the printing timing. The timing generation circuit 408 outputs a three-division starting point signal S6 to the pattern generation circuit 409. The timing generation circuit 408 sequentially outputs an A phase selection signal S7a, a B phase selection signal S7b, and a C phase selection signal S7c to the driving waveform generation circuit 410.

In response to the input of the data latch signal S5, the adjustment register 404 latches the 432-bit adjustment data CPVD stored in the adjustment shift register 403 (adjustment storage unit)

In response to the input of the data latch signal S5, the image register 407 latches the 432-bit image data RD stored in the image shift register 406 (image storage unit)

The conversion circuit 405 acquires the 2-bit sensitivity data CPVF from the setting register 402. The conversion circuit 405 converts the adjustment data Gx_CPVD (where x=1 to 108) for each of the groups G1 to G108 latched in the adjustment register 404 into 6-bit adjustment effective data Gx_VCD (where x=1 to 108) on the basis of the sensitivity data CPVF (conversion unit). The data G1_VCD indicates adjustment effective data for the channels ch.1, ch.2 and ch.3 included in the group G1. The data G2_VCD indicates adjustment effective data for the channels ch.4, ch.5 and ch.6 included in the group G2. The data G108_VCD indicates adjustment effective data for the channels ch.322, ch.323 and ch.324 included in the group G108.

In response to the input of the three-division starting point signal S6, the pattern generation circuit 409 generates a waveform pattern of a driving pulse signal according to pattern data stored in the setting register 402. The pattern generation circuit 409 outputs reference timing signals S11 to S16 to the driving waveform generation circuit 410 on the basis of the generated waveform pattern. The reference timing signals S11 to S16 will be described later.

The driving waveform generation circuit 410 generates a driving pulse signal for each of the channels ch.1 to ch.324 on the basis of the image data RD latched in the image register 407 and the adjustment effective data Gx_VCD (where x=1 to 108) obtained by the conversion circuit 405. The driving waveform generation circuit 410 generates the driving pulse signal by using the positive potential +V, the ground potential GND, and the negative potential −V according to the waveform pattern generated by the pattern generation circuit 409. If the A phase selection signal S7a is input, the driving waveform generation circuit 410 outputs the driving pulse signal to the channels ch.1, ch.4, . . . , and ch.322 included in the A phase. If the B phase selection signal S7b is input, the driving waveform generation circuit 410 outputs the driving pulse signal to the channels ch.2, ch.5, . . . , and ch.323 included in the B phase. If the C phase selection signal S7c is input, the driving waveform generation circuit 410 outputs the driving pulse signal to the channels ch.3, ch.6, . . . , and ch.324 included in the C phase (generation and output unit).

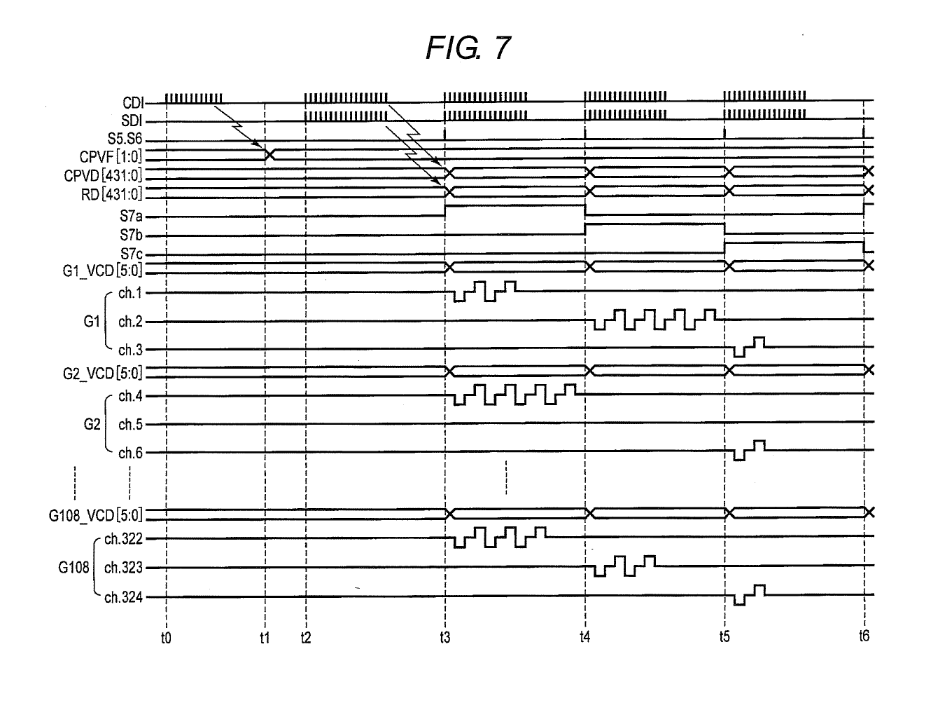

FIG. 7 is a timing diagram illustrating various signal waveforms related to the head driver 101. In FIG. 7, a waveform “CDI” indicates the CDI signal which is input to the analysis circuit 401. A waveform “SDI” indicates the SDI signal which is input to the analysis circuit 401. A waveform “S5 and S6” respectively indicates the data latch signal S5 which is output from the timing generation circuit 408 to the adjustment register 404 and the image register 407, and the three-division starting point signal S6 which is output from the timing generation circuit 408 to the pattern generation circuit 409. A waveform “CPVF [1:0] ” indicates the sensitivity data CPVF which is acquired from the setting register 402 by the conversion circuit 405. [1:0] indicates that the sensitivity data CPVF is 2 bits. A waveform “CPVD [431:0]” indicates the adjustment data CPVD latched in the adjustment register 404. A waveform “RD [431:0] ” indicates the image data RD latched in the image register 407. [431:0] indicates that each of the adjustment data CPVD and the image data RD is 432 bits. Waveforms “S7a”, “S7b” and “S7c” respectively indicate the A phase selection signal, the B phase selection signal, and the C phase selection signal which are output from the timing generation circuit 408 to the driving waveform generation circuit 410.

In FIG. 7, a waveform “Gx_VCD [5:0] (where x=1 to 108)” indicates the adjustment effective data Gx_VCD (where x=1 to 108) for each of the groups G1 to G108, which is output from the conversion circuit 405 to the driving waveform generation circuit 410. [5:0] indicates that the adjustment effective data VCD is 6 bits. Waveforms “ch.1 to ch.324” respectively indicate driving pulse signals which are output from the driving waveform generation circuit 410 to the channels ch.1 to ch.324.

Hereinafter, a description will be made of an operation of the head driver 101 with reference to the timing diagram of FIG. 7.

First, at the time point t0, leading data of the CDI signal is input to the analysis circuit 401. The leading data of the CDI signal is a serial data sequence of a total of 297 bits formed of a 1-bit start bit, an 8-bit setting data recording command, and 288-bit setting data. Pattern data and 2-bit sensitivity data CPVF used to generate a driving waveform pattern are included in the setting data of 288 bits, that is, 36 bytes.

If the setting data recording command is detected from the leading data of the CDI signal, the analysis circuit 401 enables the permission signal S1 for the setting register 402. The analysis circuit 401 recognizes data following the setting data recording command as the setting data and outputs the setting data to the setting register 402. If the permission signal S1 is enabled, the setting register 402 stores the setting data output from the analysis circuit 401.

If the outputting of the setting data is finished, the analysis circuit 401 disables the permission signal S1. If the permission signal S1 is disabled, the setting register 402 holds the setting data. If the setting data is held in the setting register 402, the sensitivity data CPVF which is received by the conversion circuit 405 from the setting register 402 is updated to the latest value (the time point t1).

Next, at the time point t2, second data of the CDI signal and leading data of the SDI signal are input to the analysis circuit 401. The second data of the CDI signal is a serial data sequence of a total of 441 bits formed of a 1-bit start bit, an 8-bit adjustment data recording command, and 432-bit adjustment data CPVD. The leading data of the SDI signal is a serial data sequence of a total of 441 bits formed of a 1-bit start bit, an 8-bit image data recording command, and 432-bit image data RD.

If the adjustment data recording command is detected from the second data of the CDI signal, the analysis circuit 401 enables the permission signal S2 for the adjustment shift register 403. The analysis circuit 401 recognizes data following the adjustment data recording command as the adjustment data CPVD and outputs the adjustment data CPVD to the adjustment shift register 403. If the permission signal S2 is enabled, the adjustment shift register 403 sequentially shifts and stores the adjustment data CPVD output from the analysis circuit 401. If the outputting of the adjustment data CPVD is finished, the analysis circuit 401 disables the permission signal S2. If the permission signal S2 is disabled, the adjustment shift register 403 holds the adjustment data CPVD.

If the image data recording command is detected from the leading data of the SDI signal, the analysis circuit 401 enables the permission signal S3 for the image shift register 406. The analysis circuit 401 recognizes data following the image data recording command as the image data RD and outputs the image data RD to the image shift register 406. If the permission signal S3 is enabled, the image shift register 406 sequentially shifts and stores the image data RD output from the analysis circuit 401. If the outputting of the image data RD is finished, the analysis circuit 401 disables the permission signal S3. If the permission signal S3 is disabled, the image shift register 406 holds the image data RD.

If the image data recording command is detected from the leading data of the SDI signal, the analysis circuit 401 disables the permission signal S4 for the timing generation circuit 408. If the permission signal S4 is disabled, the timing generation circuit 408 becomes reset.

Next, at the time point t3, third data of the CDI signal and second data of the SDI signal are input to the analysis circuit 401. The third data of the CDI signal is a 441-bit serial data sequence including the adjustment data CPVD in the same manner as the second data. The second data of the SDI signal is a 441-bit serial data sequence including the image data RD in the same manner as the leading data.

If the image data recording command is detected from the second data of the SDI signal, the analysis circuit 401 enables the permission signal S4 for the timing generation circuit 408. If the permission signal S4 is enabled, the timing generation circuit 408 transmits the data latch signal S5 to the adjustment register 404 and the image register 407. The timing generation circuit 408 transmits the three-division starting point signal S6 to the pattern generation circuit 409 along with the data latch signal S5. In addition, the timing generation circuit 408 enables the A phase selection signal S7a for the driving waveform generation circuit 410.

If the data latch signal S5 is received, the adjustment register 404 latches the adjustment data CPVD held in the adjustment shift register 403. If the data latch signal S5 is received, the image register 407 latches the image data RD held in the image shift register 406. If the three-division starting point signal S6 is received, the pattern generation circuit 409 generates the reference timing signals S11 to S16 on the basis of the pattern data held in the setting register 402. The generated reference timing signals S11 to S16 are transmitted to the driving waveform generation circuit 410.

If the adjustment data CPVD is latched in the adjustment register 404, the conversion circuit 405 converts the adjustment data CPVD into the adjustment effective data VCD by using the sensitivity data CPVF. The adjustment effective data VCD is transmitted to the driving waveform generation circuit 410.

If the image data RD is latched in the image register 407, the image data RD is transmitted to the driving waveform generation circuit 410.

The driving waveform generation circuit 410 generates driving pulse signals connected to the 108 channels by using the image data RD and the adjustment effective data VCD on the basis of the reference timing signals S11 to S16. At this time, as a phase selection signal, the A phase selection signal S7a is enabled. For this reason, the driving pulse signals corresponding to 108 channels, generated by the driving waveform generation circuit 410, are output to the channels ch.1, ch.4, . . . , and ch.322 included in the A phase of the groups G1 to G108.

Therefore, the adjustment data CPVD which is extracted from the second data of the CDI signal received at the time point t2 and is latched in the adjustment register 404 is adjustment data for the A phase of the first line. The image data RD which is extracted from the leading data of the SDI signal received at the time point t2 and is latched in the image register 407 is image data for the A phase of the first line. At the time point t3, the image data RD for the A phase is printed by using the driving pulse signal which is adjusted by the adjustment data CPVD for the A phase. In other words, the period before the time point t3 is a printing preparation stage, and printing is started at the time point t3.

On the other hand, if the adjustment data recording command is detected from third data of the CDI signal received at the time point t3, the analysis circuit 401 enables the permission signal S2 for the adjustment shift register 403. The subsequent operation is the same as the operation performed when the adjustment data recording command is detected from the second data.

Similarly, if the image data recording command is detected from second data of the SDI signal received at the time point t3, the analysis circuit 401 enables the permission signal S3 for the image shift register 406. The subsequent operation is the same as the operation performed when the image data recording command is detected from the leading data. However, the analysis circuit 401 does not disable the permission signal S4 for the timing generation circuit 408.

Next, at the time point t4, fourth data of the CDI signal and third data of the SDI signal are input to the analysis circuit 401. The fourth data of the CDI signal is also a 441-bit serial data sequence including the adjustment data CPVD in the same manner as the second data and the third data. The third data of the SDI signal is a 441-bit serial data sequence including the image data RD in the same manner as the leading data and the second data. Therefore, the analysis circuit 401 enables both the permission signal S2 for the adjustment shift register 403 and the permission signal S3 for the image shift register 406. The analysis circuit 401 outputs the adjustment data CPVD to the adjustment shift register 403 and outputs the image data RD to the image shift register 406. At this time, the image data RD is also output to the timing generation circuit 408.

If a leading bit of the image data RD is detected, the timing generation circuit 408 transmits the data latch signal S5 to the adjustment register 404 and the image register 407. The timing generation circuit 408 transmits the three-division starting point signal S6 to the pattern generation circuit 409 along with the data latch signal S5. The timing generation circuit 408 enables the B phase selection signal S7b for the driving waveform generation circuit 410.

Operations of the adjustment register 404 and the image register 407 receiving the data latch signal S5 and an operation of the pattern generation circuit 409 receiving the three-division starting point signal S6 are performed in the same manner as the operations at the time point t3. Operations of the conversion circuit 405 and the driving waveform generation circuit 410 are also performed in the same manner as the operations at the time point t3. In this case, as a phase selection signal, the B phase selection signal S7b is enabled. For this reason, the driving pulse signals corresponding to 108 channels, generated by the driving waveform generation circuit 410, are output to the channels ch.2, ch.5, . . . , and ch.323 included in the B phase of the groups G1 to G108.

Therefore, the adjustment data CPVD which is extracted from the third data of the CDI signal received at the time point t3 and is latched in the adjustment register 404 is adjustment data for the B phase of the first line. The image data RD which is extracted from the second data of the SDI signal received at the time point t3 and is latched in the image register 407 is image data for the B phase of the first line. At the time point t4, the image data RD for the B phase is printed by using the driving pulse signal which is adjusted by the adjustment data CPVD for the B phase.

Next, at the time point t5, fifth data of the CDI signal and fourth data of the SDI signal are input to the analysis circuit 401. The fifth data of the CDI signal is also a 441-bit serial data sequence including the adjustment data CPVD in the same manner as the second data to the fourth data. The fourth data of the SDI signal is a 441-bit serial data sequence including the image data RD in the same manner as the first data to the third data. Therefore, the analysis circuit 401 enables both the permission signal S2 for the adjustment shift register 403 and the permission signal S3 for the image shift register 406. The analysis circuit 401 outputs the adjustment data CPVD to the adjustment shift register 403 and outputs the image data RD to the image shift register 406. At this time, the image data RD is also output to the timing generation circuit 408.

If a leading bit of the image data RD is detected, the timing generation circuit 408 transmits the data latch signal S5 to the adjustment register 404 and the image register 407. The timing generation circuit 408 transmits the three-division starting point signal S6 to the pattern generation circuit 409 along with the data latch signal S5. The timing generation circuit 408 enables the C phase selection signal S7c for the driving waveform generation circuit 410.

Operations of the adjustment register 404 and the image register 407 receiving the data latch signal S5 and an operation of the pattern generation circuit 409 receiving the three-division starting point signal S6 are performed in the same manner as the operations at the time points t3 and t4. Operations of the conversion circuit 405 and the driving waveform generation circuit 410 are also performed in the same manner as the operations at the time points t3 and t4. In this case, as a phase selection signal, the C phase selection signal S7c is enabled. For this reason, the driving pulse signals corresponding to 108 channels, generated by the driving waveform generation circuit 410, are output to the channels ch.3, ch.6, . . . , and ch.324 included in the C phase of the groups G1 to G108.

Therefore, the adjustment data CPVD which is extracted from the fourth data of the CDI signal received at the time point t4 and is latched in the adjustment register 404 is adjustment data for the C phase of the first line. The image data RD which is extracted from the third data of the SDI signal received at the time point t4 and is latched in the image register 407 is image data for the C phase of the first line. At the time point t5, the image data RD for the C phase is printed by using the driving pulse signal which is adjusted by the adjustment data CPVD for the C phase.

At the time point t6 and the subsequent period, the operations at the time points t3 to t5 are repeatedly performed. As a result, the channels ch.1 to ch.324 of the ink jet head 100 are driven in a three-division manner, and the image data RD is printed.

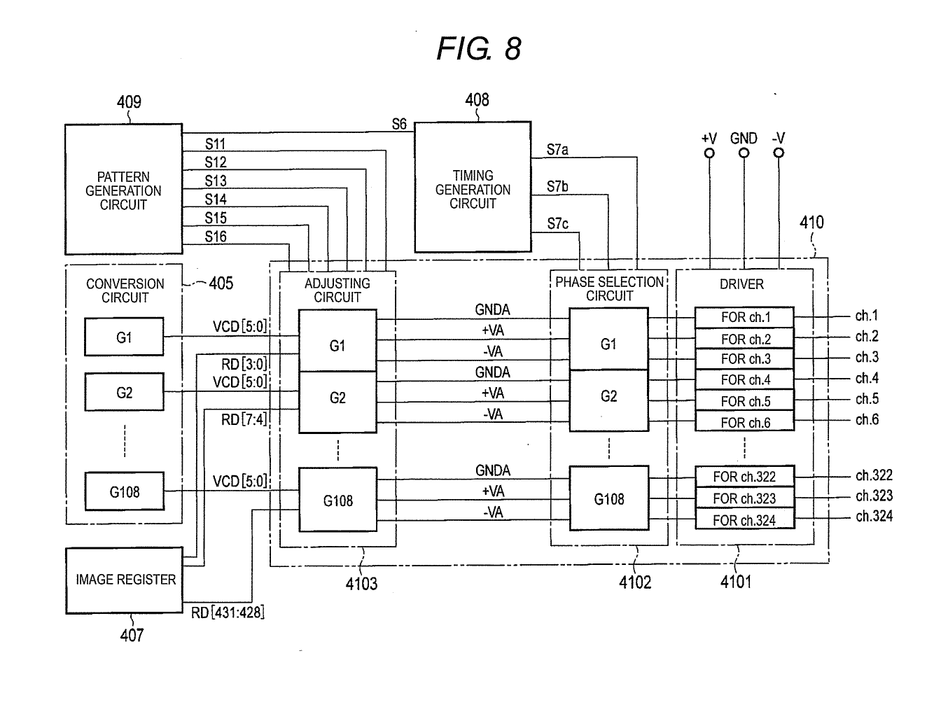

FIG. 8 is a block diagram illustrating details of the driving waveform generation circuit 410 and relationships with the peripheral circuits (the conversion circuit 405, the image register 407, the timing generation circuit 408, and the pattern generation circuit 409) thereof. The driving waveform generation circuit 410 includes a driver 4101, a phase selection circuit 4102, and an adjusting circuit 4103.

The driver 4101 is provided for each of the channels ch.1 to ch.324. The phase selection circuit 4102 and the adjusting circuit 4103 are provided for each group including three adjacent channels of the groups G1 to G108. In other words, the phase selection circuit 4102 and the adjusting circuit 4103 of the group G1 correspond to the channels ch.1, ch.2 and ch.3. The phase selection circuit 4102 and the adjusting circuit 4103 of the group G2 correspond to the channels ch.4, ch.5 and ch.6. This is also the same for the groups G3 to G108. In other words, the phase selection circuit 4102 and the adjusting circuit 4103 of the group G108 correspond to the channels ch.322, ch.323 and ch.324.

The conversion circuit 405 is also provided for each of the groups G1 to G108 in the same manner as the phase selection circuit 4102 and the adjusting circuit 4103. In other words, the conversion circuit 405 of the group G1 corresponds to the channels ch.1, ch.2 and ch.3. The conversion circuit 405 of the group G2 corresponds to the channels ch.4, ch.5 and ch.6. This is also the same for the groups G3 to G108. In other words, the conversion circuit 405 of the group G108 corresponds to the channels ch.322, ch.323 and ch.324.

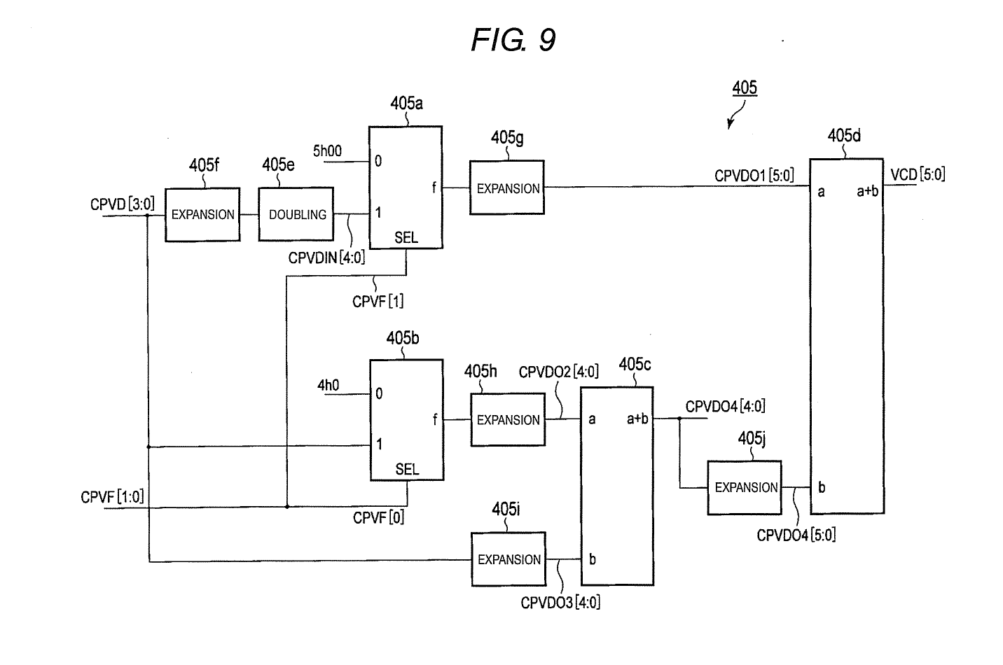

FIG. 9 is a block diagram illustrating details of a configuration of the conversion circuit 405. The conversion circuits 405 of the groups G1 to G108 have the same configuration. FIG. 9 illustrates the conversion circuit 405 of the group G1.

The conversion circuit 405 includes two selectors 405a and 405b, two adders 405c and 405d, a doubling circuit 405e, and five expanders 405f, 405g, 405h, 405i and 405j.

Both of the selectors 405a and 405b output a bit which is input to a “0” input terminal from an f output terminal when a value which is input to a select terminal SEL has a low level “0”. The selectors 405a and 405b output a bit which is input to a “1” input terminal from the f output terminal when a value which is input to the select terminal SEL has a high level “1”. Both of the adders 405c and 405d add a bit which is input to an “a” input terminal to a bit which is input to a “b” input terminal, and output a sum bit as a result of the addition from an “a+b” output terminal. The doubling circuit 405e shifts an input bit to the left side by 1 bit. The expanders 405f, 405g, 405h, 405i and 405j all expand a high-order 1 bit.

The conversion circuit 405 of the group G1 receives the 4-bit adjustment data CPVD and the 2-bit sensitivity data CPVF. The adjustment data CPVD is input to the expander 405f, the expander 405i, and the “1” input terminal of the selector 405b. The sensitivity data CPVF has a high-order 1 bit which is input to the selection terminal SEL of the selector 405a and a low-order 1 bit which is input to the select terminal SEL of the selector 405b.

The expander 405f and the expander 405i add “0” of 1 bit to a high-order side of the 4-bit adjustment data CPVD so as to output 5-bit adjustment data CPVD. The 5-bit adjustment data CPVD which is output from the expander 405f is given to the doubling circuit 405e. 5-bit adjustment data CPVDO3 which is output from the expander 405i is given to the “b” input terminal of the adder 405c.

The doubling circuit 405e shifts each bit of the adjustment data CPVD to the high-order side by 1 bit. As a result, the adjustment data CPVD is doubled. The doubled adjustment data CPVDIN is given to the “1” input terminal of the selector 405a.

If a high-order 1 bit of the sensitivity data CPVF is “1”, the selector 405a outputs the doubled adjustment data CPVDIN to the expander 405g. If a low-order 1 bit of the sensitivity data CPVF is “0”, the selector 405b outputs the 4-bit adjustment data CPVD to the expander 405h.

The expander 405g adds “0” of 1 bit to a high-order side of the adjustment data CPVDIN which is output from the selector 405a so as to output 6-bit adjustment data CPVDO1. The 6-bit adjustment data CPVDO1 which is output from the expander 405g is given to the “a” input terminal of the adder 405d.

The expander 405h adds “0” of 1 bit to a high-order side of the adjustment data CPVD which is output from the selector 405b so as to output 5-bit adjustment data CPVDO2. The 5-bit adjustment data CPVDO2 which is output from the expander 405h is given to the “a” input terminal of the adder 405c.

The adder 405c adds the adjustment data CPVDO2 given to the “a” input terminal to the adjustment data CPVDO3 given to the “b” input terminal. The adder 405c gives 5-bit adjustment data CPVDO4 which is an addition result to the expander 405j.

The expander 405j adds “0” of 1 bit to a high-order side of the adjustment data CPVDO4 which is output from the adder 405c so as to output 6-bit adjustment data CPVDO4. The 6-bit adjustment data CPVDO4 which is output from the expander 405i is given to the “b” input terminal of the adder 405d.

The adder 405d adds the adjustment data CPVDO1 given to the “a” input terminal to the adjustment data CPVDO4 given to the “b” input terminal. The adder 405d gives 6-bit data which is an addition result to the adjusting circuit 4103 of the group G1 as the adjustment effective data VCD.

In the present exemplary embodiment, the sensitivity data CPVF is 2 bits. In other words, the sensitivity data CPVF has four patterns including 00h=0, 01h=1, 10h=2,and 11h=3. On the other hand, the adjustment data CPVD for each group is 4 bits. In other words, the adjustment data CPVD is represented as integers of which the minimum value is “0” and the maximum value is “15”.

For example, if the sensitivity data CPVF is “0”, and the adjustment data CPVD is “15”, in the conversion circuit 405, the 6-bit adjustment data CPVDO1 which is an expansion result in the expander 405g becomes “0”. The 5-bit adjustment data CPVDO2 which is an expansion result in the expander 405h also becomes “0”. The 5-bit adjustment data CPVDO3 which is an expansion result in the expander 405i becomes “15”. Therefore, the 6-bit adjustment data CPVDO4 which is obtained in the expander 405j by expanding an addition result in the adder 405c becomes “15”. As a result, the adjustment effective data VCD which is an addition result in the adder 405d becomes “15”.

For example, if the sensitivity data CPVF is “1”, and the adjustment data CPVD is “15”, in the conversion circuit 405, the 6-bit adjustment data CPVDO1 which is an expansion result in the expander 405g becomes “0”. The 5-bit adjustment data CPVDO2 which is an expansion result in the expander 405h also becomes “15”. The 5-bit adjustment data CPVDO3 which is an expansion result in the expander 405i becomes “15”. Therefore, the 6-bit adjustment data CPVDO4 which is obtained in the expander 405j by expanding an addition result in the adder 405c becomes “30”. As a result, the adjustment effective data VCD which is an addition result in the adder 405d becomes “30”.

For example, if the sensitivity data CPVF is “2”, and the adjustment data CPVD is “15”, in the conversion circuit 405, the 6-bit adjustment data CPVDO1 which is an expansion result in the expander 405g becomes “30”. The 5-bit adjustment data CPVDO2 which is an expansion result in the expander 405h also becomes “0”. The 5-bit adjustment data CPVDO3 which is an expansion result in the expander 405i becomes “15”. Therefore, the 6-bit adjustment data CPVDO4 which is obtained in the expander 405j by expanding an addition result in the adder 405c becomes “15”. As a result, the adjustment effective data VCD which is an addition result in the adder 405d becomes “45”.

For example, if the sensitivity data CPVF is “3”, and the adjustment data CPVD is “15”, in the conversion circuit 405, the 6-bit adjustment data CPVDO1 which is an expansion result in the expander 405g becomes “30”. The 5-bit adjustment data CPVDO2 which is an expansion result in the expander 405h also becomes “15”. The 5-bit adjustment data CPVDO3 which is an expansion result in the expander 405i becomes “15”. Therefore, the 6-bit adjustment data CPVDO4 which is obtained in the expander 405j by expanding an addition result in the adder 405c becomes “30”. As a result, the adjustment effective data VCD which is an addition result in the adder 405d becomes “60”.

As described above, if the sensitivity data CPVF is “0”, a value of the adjustment data CPVD is output to the driving waveform generation circuit 410 as the adjustment effective data VCD without being changed. If the sensitivity data CPVF is “1”, a doubled value of the adjustment data CPVD is output to the driving waveform generation circuit 410 as the adjustment effective data VCD. If the sensitivity data CPVF is “2”, a tripled value of the adjustment data CPVD is output to the driving waveform generation circuit 410 as the adjustment effective data VCD. If the sensitivity data CPVF is “3”, a quadrupled value of the adjustment data CPVD is output to the driving waveform generation circuit 410 as the adjustment effective data VCD. In other words, the sensitivity is 1 time if the sensitivity data CPVF is “0”, the sensitivity is 2 times if “1”, the sensitivity is 3 times if “2”, and the sensitivity is 4 times if “3”.

The description is continued by referring to FIG. 8 again.

Each adjusting circuit 4103 of the groups G1 to G108 receives the reference timing signals S11 to S16 which are transmitted from the pattern generation circuit 409. As content of the reference timing signals S11 to S16, the signal S11 is a driving permission signal for the driving waveform generation circuit 410, the signal S12 is a drop starting pulse signal, the signal S13 is a drop ending pulse signal, the signal S14 is a starting pulse signal of the negative potential −V, the signal S15 is a starting pulse signal of the ground potential GND, and the signal S16 is a starting pulse signal of the positive potential +V.

Each adjusting circuit 4103 acquires the image data RD and the adjustment effective data VCD for the same group from the image register 407 and the conversion circuit 405. For example, the adjusting circuit 4103 corresponding to the group G1 generates driving pulse waveforms for the channels ch.1, ch.2 and ch.3 on the basis of the image data RD, the adjustment effective data G1_VCD, and the respective reference timing signals S11 to S16. The adjusting circuit 4103 outputs a driving permission signal GNDA for the ground potential GND, a driving permission signal +VA for the positive potential +V, and a driving permission signal −VA for the negative potential −V to the phase selection circuit 4102 of the group G1 according to the generated driving pulse waveforms.

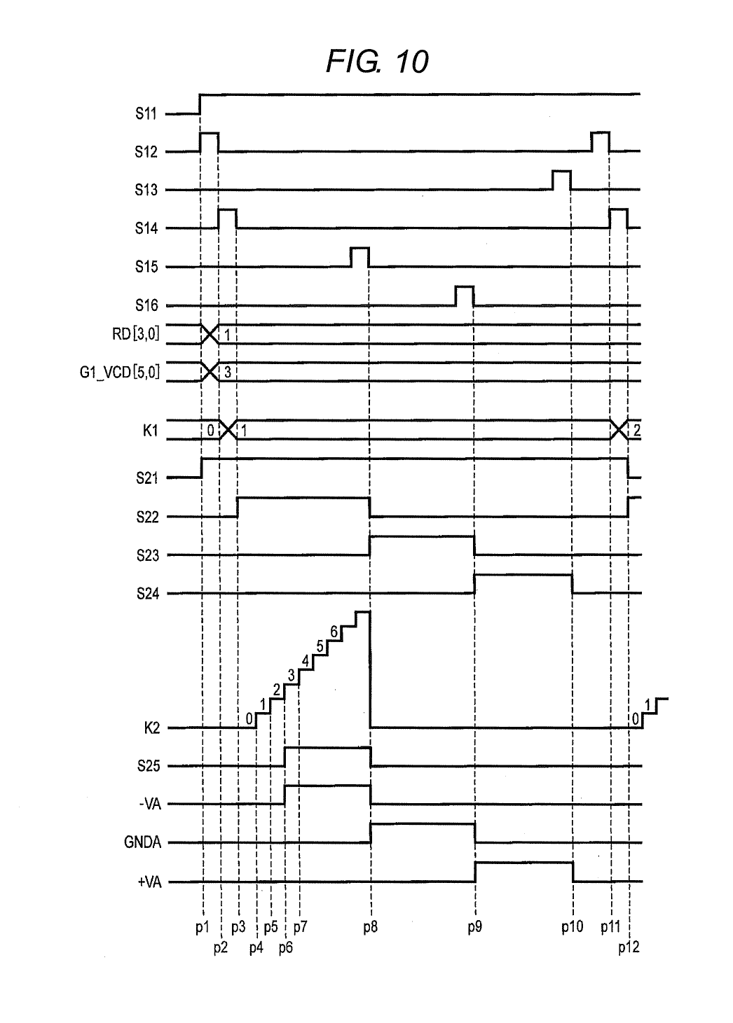

FIG. 10 is a timing diagram of various signal waveforms related to the adjusting circuit 4103 corresponding to the group G1. In FIG. 10, waveforms “S11 to S16” indicate reference timing signals which are input to the adjusting circuit 4103 from the pattern generation circuit 409. In other words, the waveform “S11” indicates the driving permission signal for the driving waveform generation circuit 410. The waveform “S12” indicates the drop starting pulse signal. The waveform “S13” indicates the drop ending pulse signal. The waveform “S14” indicates the starting pulse signal of the negative potential −V. The waveform “S15” indicates the starting pulse signal of the ground potential GND. The waveform “S16” indicates the starting pulse signal S16 of the positive potential +V.

In FIG. 10, a waveform “RD[3:0]” indicates image data for the group G1, which is acquired by the adjusting circuit 4103 from the image register 407. A waveform “G1_VCD[5:0]” indicates adjustment effective data for the group G1, which is acquired by the adjusting circuit 4103 from the conversion circuit 405.

In FIG. 10, waveforms “K1, K2, S21, S22, S23, S24, and S25” all indicate internal signals of the adjusting circuit 4103. In other words, the waveform “K1” indicates a drop counter. The drop counter K1 counts the drop starting pulse signal S12. The waveform “S21” indicates a drop permission signal. The drop permission signal S21 is enabled if a value of the image data RD is smaller than a value of the drop counter K1. Each of the drop counter K1 and the drop permission signal S21 takes AND (logical product) with the driving permission signal S11 for the driving waveform generation circuit 410. FIG. 10 illustrates a case where a value of the image data RD is “1”.

The waveform “S22” indicates a generation permission signal of the negative potential −V. The waveform “S23” indicates a generation permission signal of the ground potential GND. The waveform “S24” indicates a generation permission signal of the positive potential +V. The generation permission signals S22, S23 and S24 are all permitted to be output if the drop permission signal S21 is enabled. The generation permission signal S22 of the negative potential −V is set by the starting pulse signal S14 of the negative potential −V, and is reset by the starting pulse signal S15 of the ground potential GND. The generation permission signal S23 of the ground potential GND is set by the starting pulse signal S15 of the ground potential GND, and is reset by the starting pulse signal S16 of the positive potential +V. The generation permission signal S24 of the positive potential +V is set by the starting pulse signal S16 of the positive potential +V, and is reset by the drop ending pulse signal S13.

The waveform “K2” indicates an adjustment counter. The adjustment counter K2 increases its count number according to input of the clock signal CLK while the generation permission signal S22 of the negative potential −V is enabled. is enabled If the generation permission signal S22 is disabled, the adjustment counter K2 is reset.

The waveform “S25” indicates an adjusting signal. If a value of the adjustment counter K2 is equal to or greater than a value of the adjustment effective data G1_VCD, the adjusting signal S25 is enabled. If the generation permission signal S22 of the negative potential −V is disabled, the adjusting signal S25 is disabled. FIG. 10 illustrates a case where a value of the adjustment effective data G1_VCD is “3”.

In FIG. 10, waveforms “−VA, GNDA, and +VA” all indicate signals which are output from the adjusting circuit 4103 to the phase selection circuit 4102. In other words, the waveform “−VA” indicates the driving permission signal of the negative potential −V. The waveform “GNDA” indicates the driving permission signal of the ground potential GND. The waveform “+VA” indicates the driving permission signal of the positive potential +V.

Hereinafter, a description will be made of an operation of the adjusting circuit 4103 with reference to the timing diagram of FIG. 10.

At the time point p1, if the driving permission signal S11 of the driving waveform generation circuit 410 is enabled, the drop starting pulse signal S12 is output. At this time, a value of the drop counter K1 is smaller than the value “1” of the image data RD. For this reason, the drop permission signal S21 is enabled. As a result, the drop counter K1 increases its count number at the time point p2 at which the starting pulse signal S12 falls. In addition, the starting pulse signal S14 of the negative potential −V is output.

Next, at the time point p3 at which the starting pulse signal S14 falls, the generation permission signal S22 of the negative potential −V is enabled. If the generation permission signal S22 is enabled, the adjustment counter K2 is activated. The adjustment counter K2 increases its count number whenever the clock signal CLK is input at timings of the time points p4, p5, p6, p7, . . . .

At the time point p6, if a value of the adjustment counter K2 is “3”, the value of the adjustment counter K2 is equal to or greater than the value “3” of the adjustment effective data G1_VCD. As a result, the adjusting signal S25 is enabled. If the adjusting signal S25 is enabled, the driving permission signal −VA of the negative potential −V is enabled.

Next, the starting pulse signal S15 of the ground potential GND is output on the basis of the pattern data. At the time point p8, if the starting pulse signal S15 falls, the generation permission signal S22 of the negative potential −V is disabled. Simultaneously, the generation permission signal S23 of the ground potential GND is enabled.

If the generation permission signal S22 is disabled, the adjustment counter K2 is cleared. As a result, the adjusting signal S25 is disabled.

If the adjusting signal S25 is disabled, the driving permission signal −VA of the negative potential −V is disabled. If the generation permission signal S23 is enabled, the driving permission signal of the ground potential GND is enabled.

Next, the starting pulse signal S16 of the positive potential +V is output on the basis of the pattern data. At the time point p9, if the starting pulse signal S16 falls, the generation permission signal S23 of the ground potential GND is disabled. Simultaneously, the generation permission signal S24 of the positive potential +V is enabled. If the generation permission signal S23 is disabled, the driving permission signal GNDA of the ground potential GND is disabled. If the generation permission signal S24 is enabled, the driving permission signal +VA of the positive potential +V is enabled.

Next, the drop ending pulse signal S13 is output on the basis of the pattern data. At the time point p10, if the ending pulse signal S13 falls, the generation permission signal S24 of the positive potential +V is disabled. If the generation permission signal S24 is disabled, the driving permission signal +VA of the positive potential +V is disabled.

As illustrated in FIG. 10, if a value of the adjustment effective data G1_VCD is “3”, the driving permission signal −VA of the negative potential is enabled at the time point p6 at which the adjustment counter K2 counts “3”.

If a value of the adjustment effective data G1_VCD is “4”, the driving permission signal −VA is not enabled until the adjustment counter K2 counts “4”. The driving permission signal −VA is enabled at the time point p7. If a value of the adjustment effective data G1_VCD is “1”, the driving permission signal −VA of the negative potential is enabled at the time point p5 at which the adjustment counter K2 counts “1”.

As mentioned above, the adjusting circuit 4103 adjusts timing at which the driving permission signal −VA of the negative potential is enabled according to a value of the adjustment effective data G1_VCD.

FIG. 10 illustrates the various signal waveforms related to the adjusting circuit 4103 corresponding to the group G1. Various signal waveforms related to the adjusting circuits 4103 corresponding to the other groups G2 to G108 are the same as the various signal waveforms illustrated in FIG. 10 and thus description thereof will be omitted here.

The description is continued by referring to FIG. 8 again. The phase selection circuit 4102 of each of the groups G1 to G108 receives the A phase selection signal S7a, the B phase selection signal S7b, and the C phase selection signal S7c which are transmitted from the timing generation circuit 408.

If the A phase selection signal S7a is enabled, for example, the phase selection circuit 4102 corresponding to the group G1 selects the driver 4101 of the channel ch.1 included in the A phase. The phase selection circuit 4102 outputs the driving permission signals GNDA, +VA and −VA sent from the adjusting circuit 4103 to the selected driver 4101 while the A phase selection signal S7a is enabled.

If the B phase selection signal S7b is enabled, for example, the phase selection circuit 4102 corresponding to the group G1 selects the driver 4101 of the channel ch.2 included in the B phase. The phase selection circuit 4102 outputs the driving permission signals GNDA, +VA and −VA sent from the adjusting circuit 4103 to the selected driver 4101 while the B phase selection signal S7b is enabled.

If the C phase selection signal S7c is enabled, for example, the phase selection circuit 4102 corresponding to the group G1 selects the driver 4101 of the channel ch.3 included in the C phase. The phase selection circuit 4102 outputs the driving permission signals GNDA, +VA and −VA sent from the adjusting circuit 4103 to the selected driver 4101 while the C phase selection signal S7c is enabled.

The phase selection circuits 4102 corresponding to the other groups G2 to G108 also operate in the same manner as described above according to the A phase selection signal S7a, the B phase selection signal S7b, and the C phase selection signal S7c.

The positive potential +V, the negative potential −V, and the ground potential GND are applied to the driver 4101 of each of the channels ch.1 to ch.324 from a power source. If a signal from the phase selection circuit 4102 is the driving permission signal GNDA, the respective drivers 4101 apply the ground potential GND to electrodes of the corresponding channels ch.1 to ch.324. If a signal from the phase selection circuit 4102 is the driving permission signal +VA, the respective drivers 4101 apply the positive potential +V to electrodes of the corresponding channels ch.1 to ch.324. If a signal from the phase selection circuit 4102 is the driving permission signal −VA, the respective drivers 4101 apply the negative potential −V to electrodes of the corresponding channels ch.1 to ch.324. Due to the application of the ground potential GND, the positive potential +V, and the negative potential −V, driving pulse signals based on the pattern data are output to the electrodes of the channels ch.1 to ch.324.

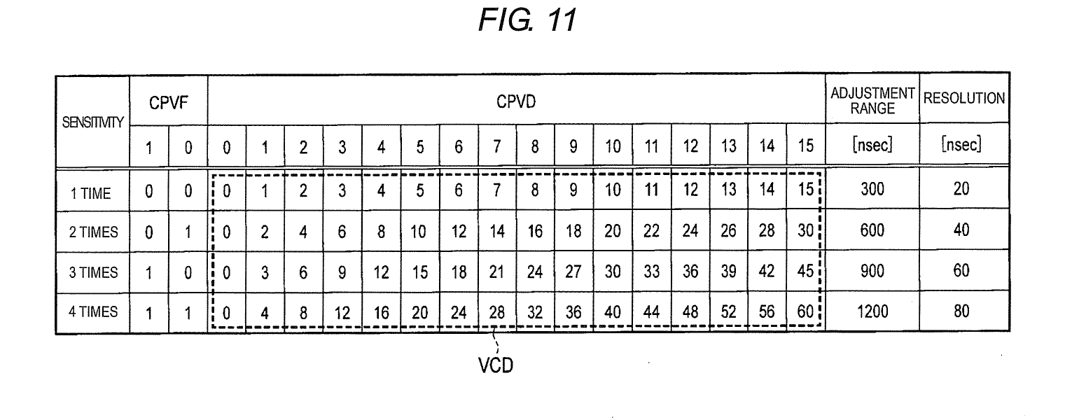

FIG. 11 is a diagram illustrating that a value of the adjustment effective data VCD calculated by the conversion circuit 405 is correlated with an adjustment range [nsec] and a resolution [nsec]. As described above, the sensitivity is 1 time if the sensitivity data CPVF is “0”, the sensitivity is 2 times if “1”, the sensitivity is 3 times if “2”, and the sensitivity is 4 times if “3”. Therefore, values of the adjustment effective data VCD for the adjustment data CPVD from “0” to “15” are as illustrated in FIG. 11.

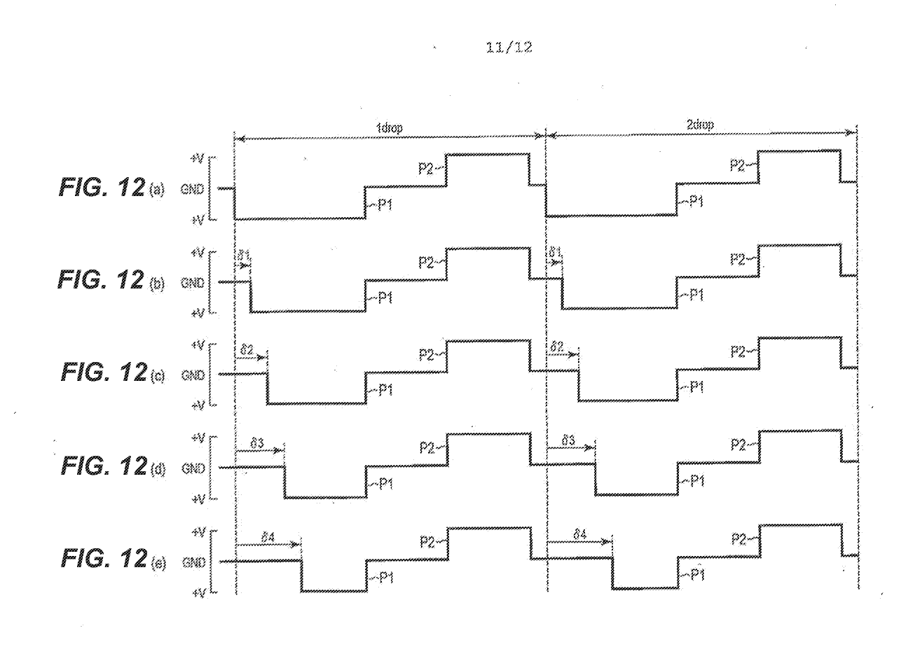

For example, if the adjustment effective data VCD is “0”, the driving permission signal −VA of the negative potential −V is enabled in synchronization with falling of the starting pulse signal S14. An example of a driving pulse signal at this time is illustrated in FIG. 12(a). In FIG. 12(a), a pulse P1 is an increase pulse. A pulse P2 is a decrease pulse.

For example, if the adjustment effective data VCD is “15”, the driving permission signal −VA of the negative potential −V is not enabled until a value of the adjustment counter K2 becomes “15” from a falling point of the starting pulse signal S14. If a value of the adjustment counter K2 becomes “15”, the driving permission signal −VA is enabled. An example of a driving pulse signal at this time is illustrated in FIG. 12(b). In FIG. 12(b), a pulse P1 is an increase pulse. A pulse P2 is a decrease pulse.

If a driving pulse signal obtained when the adjustment effective data VCD is “0” is used as a reference, a driving pulse signal obtained when the adjustment effective data VCD is “15” has start timing of the increase pulse P1 which is delayed by an adjustment time period δ1. If the sensitivity data CPVF is “0”, the adjustment effective data VCD increases by +1 as the adjustment data CPVD increases by “1”. In other words, if a range of the sensitivity data CPVF is set to “0” to “15”, a range of the adjustment effective data VCD becomes “0” to “15”. In the present exemplary embodiment, a cycle of the reference clock CLK is 20 nsec. Therefore, the resolution obtained when the sensitivity data CPVF is “0” is 20 nsec, and an adjustment range is 0 nsec to 300 nsec.

For example, if the adjustment effective data VCD is “30”, the driving permission signal −VA of the negative potential −V is not enabled until a value of the adjustment counter K2 becomes “30” from the falling point of the starting pulse signal S14. If a value of the adjustment counter K2 becomes “30”, the driving permission signal −VA is enabled. An example of a driving pulse signal at this time is illustrated in FIG. 12(c). In FIG. 12(c), a pulse P1 is an increase pulse. A pulse P2 is a decrease pulse.

If a driving pulse signal obtained when the adjustment effective data VCD is “0” is used as a reference, a driving pulse signal obtained when the adjustment effective data VCD is “30” has start timing of the increase pulse P1 which is delayed by an adjustment time period δ2. If the sensitivity data CPVF is “1”, the adjustment effective data VCD increases by +2 as the adjustment data CPVD increases by “1”. In other words, if a range of the sensitivity data CPVF is set to “0” to “15”, a range of the adjustment effective data VCD becomes “0” to “30”. In the present exemplary embodiment, a cycle of the reference clock CLK is 20 nsec. Therefore, the resolution obtained when the sensitivity data CPVF is “1” is 40 nsec, and an adjustment range is 0 nsec to 600 nsec.

For example, if the adjustment effective data VCD is “45”, the driving permission signal −VA of the negative potential −V is not enabled until a value of the adjustment counter K2 becomes “45” from the falling point of the starting pulse signal S14. If a value of the adjustment counter K2 becomes “45”, the driving permission signal −VA is enabled. An example of a driving pulse signal at this time is illustrated in FIG. 12(d). In FIG. 12(d), a pulse P1 is an increase pulse. A pulse P2 is a decrease pulse.

If a driving pulse signal obtained when the adjustment effective data VCD is “0” is used as a reference, a driving pulse signal obtained when the adjustment effective data VCD is “45” has start timing of the increase pulse P1 which is delayed by an adjustment time period δ3. If the sensitivity data CPVF is “2”, the adjustment effective data VCD increases by +3 as the adjustment data CPVD increases by “1”. In other words, if a range of the sensitivity data CPVF is set to “0” to “15”, a range of the adjustment effective data VCD becomes “0” to “45”. In the present exemplary embodiment, a cycle of the reference clock CLK is 20 nsec. Therefore, the resolution obtained when the sensitivity data CPVF is “2” is 60 nsec, and an adjustment range is 0 nsec to 900 nsec.

For example, if the adjustment effective data VCD is “60”, the driving permission signal −VA of the negative potential −V is not enabled until a value of the adjustment counter K2 becomes “60” from the falling point of the starting pulse signal S14. If a value of the adjustment counter K2 becomes “60”, the driving permission signal −VA is enabled. An example of a driving pulse signal at this time is illustrated in FIG. 12(e). In FIG. 12(e), a pulse P1 is an increase pulse. A pulse P2 is a decrease pulse.

If a driving pulse signal obtained when the adjustment effective data VCD is “0” is used as a reference, a driving pulse signal obtained when the adjustment effective data VCD is “60” has start timing of the increase pulse P1 which is delayed by an adjustment time period δ4. If the sensitivity data CPVF is “3”, the adjustment effective data VCD increases by +4 as the adjustment data CPVD increases by “1”. In other words, if a range of the sensitivity data CPVF is set to “0” to “15”, a range of the adjustment effective data VCD becomes “0” to “60”. In the present exemplary embodiment, a cycle of the reference clock CLK is 20 nsec. Therefore, the resolution obtained when the sensitivity data CPVF is “3” is 80 nsec, and an adjustment range is 0 nsec to 1200 nsec.

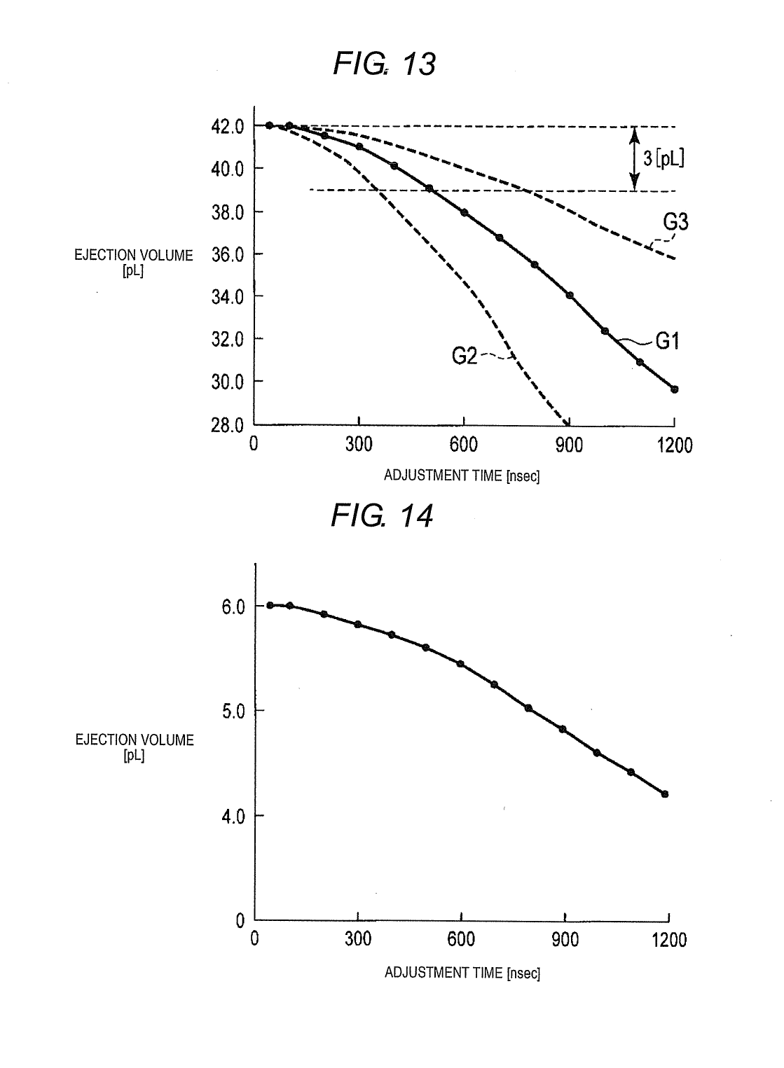

If the start timing of the increase pulse P1 is delayed by the adjustment time period δ1, δ2, δ3, or δ4, the volume of ink drops ejected from the nozzle 8 changes. FIGS. 13 and 14 illustrate test results of changes in an ejection volume of ink drops relative to the adjustment time periods. FIG. 13 illustrates a case where seven ink drops are ejected. FIG. 14 illustrates a case where a single ink drop is ejected. In both of the drawings, a longitudinal axis expresses an ejection volume [pL], and a transverse axis expresses an adjustment time period [nsec].

In FIG. 13, a solid graph G1 shows the present test result. According to the graph G1, if the adjustment time period δ is set to 300 nsec, the ejection volume is reduced by 1 pL relative to seven ink drops. If the adjustment time period δ is set to 600 nsec, the ejection volume is reduced by 4 pL relative to seven ink drops. If the adjustment time period δ is set to 900 nsec, the ejection volume is reduced by 8 pL relative to seven ink drops.

As illustrated in FIG. 14, if the adjustment time period δ is set to 0 nsec, the ejection volume of a single ink drop is 6 pL. For this reason, if a range for adjusting a variation in the ejection volume in the ink jet head 100 is 3 pL (42 pL to 39 pL), 500 nsec is necessary as the adjustment time period δ. Therefore, with reference to FIG. 11, the sensitivity data may be set to “1” (the sensitivity of 2 times)

However, an amount of change in an ejection volume differs depending on characteristics of the pressure chamber, characteristics of ink, or the like. In FIG. 13, one dashed graph G2 shows a case where an amount of change is assumed to be large. In this case, if the adjustment time period δ is set to 300 nsec, the ejection volume is reduced by 3 pL relative to seven ink drops. If the adjustment time period δ is set to 600 nsec, the ejection volume is reduced by 7 pL relative to seven ink drops. For this reason, if a range for adjusting a variation in the ejection volume in the ink jet head 100 is 3 pL (42 pL to 39 pL), 300 nsec is necessary as the adjustment time period δ. Therefore, with reference to FIG. 11, the sensitivity data may be set to “0” (the sensitivity of 1 time) or “1” (the sensitivity of 2 times).

In FIG. 13, the other dashed graph G3 shows a case where an amount of change is assumed to be small. In this case, if the adjustment time period δ is set to 300 nsec, the ejection volume is reduced by 0.5 pL relative to seven ink drops. If the adjustment time period δ is set to 600 nsec, the ejection volume is reduced by 1.5 pL relative to seven ink drops. If the adjustment time period δ is set to 900 nsec, the ejection volume is reduced by 3 pL relative to seven ink drops. For this reason, if a range for adjusting a variation in the ejection volume in the ink jet head 100 is 3 pL (42 pL to 39 pL), 900 nsec is necessary as the adjustment time period δ. Therefore, with reference to FIG. 11, the sensitivity data may be set to “2” (the sensitivity of 3 times).

Generally, the adjustment data CPVD for adjusting a variation of the ink jet head 100 employs data with a multi-value format in order to increase resolution. However, the adjustment data CPVD is preferably set to be equal to or less than the number of bits of the image data RD so that a data transmission slew rate is not reduced. The present exemplary embodiment shows a case of 4 bits which are the same as the number of bits of the image data RD.

As mentioned above, the number of bits of the adjustment data is a fixed value, and the adjustment data range and the resolution are invariable. For this reason, there is a problem in that an applicable adjustment range is narrow even if a variation caused by characteristics of the pressure chamber, characteristics of ink, or the like increases.

Therefore, in the head 100 of the present exemplary embodiment, the sensitivity data CPVF for the adjustment data CPVD is set. In the head 100, the adjustment data CPVD is converted into the adjustment effective data VCD by using the sensitivity data CPVF, and the adjustment effective data VCD is provided to generate a driving pulse waveform. Therefore, in the head 100, an adjustment range can be widened by using the adjustment data CPVD. The head 100 sets the sensitivity data CPVF before printing is performed. Thus, a data transmission slew rate is not reduced.

The present invention is not limited to the exemplary embodiment.

For example, in the exemplary embodiment, the sensitivity data is data which causes an adjustment range of the adjustment data to be an integer multiple, but may not necessarily be data which causes an integer multiple. For example, the sensitivity data may be data which causes an adjustment range of the adjustment data to be 1.5 times or 2.5 times normal. In addition, the sensitivity data may be data which causes an adjustment range of the adjustment data to be ½ times, ⅓ times, or ¼ times.

The exemplary embodiment is only an example and is not intended to limit the scope of the invention. The embodiment may be implemented in other various embodiments, and may be implemented through various omissions, replacements, and modifications within the scope without departing from the spirit of the invention. The embodiment or the modifications thereof fall within the scope or the spirit of the invention and also fall within the scope of the inventions disclosed in the claims and the equivalents thereof.

What is claimed is:

1. An ink jet head comprising:
a plurality of nozzles that eject ink drops through operations of corresponding driving elements;
an image storage unit that stores image data;
an adjustment storage unit that stores adjustment data which is set for each nozzle in order to uniformly correct variations in the ink drops ejected from the plurality of nozzles;
a setting storage unit that stores setting data for changing an adjustment range using the adjustment data;
a conversion unit that converts the adjustment data into adjustment effective data which is obtained by changing the adjustment range using the adjustment data on the basis of the setting data; and
a generation and output unit that generates a driving pulse waveform which is obtained by adjusting a reference pulse waveform of a driving pulse signal for operating the driving element by using the adjustment effective data on the basis of the image data for each nozzle, and applies the driving pulse signal with the driving pulse waveform to the driving element corresponding to each nozzle.

2. The head according to claim 1, further comprising:
an analysis and output unit that analyzes a command supplied from an external device, transmits data following the command to the image storage unit if the command is a command for recording the image data, transmits data following the command to the adjustment storage unit if the command is a command for recording the adjustment data, and transmits data following the command to the setting storage unit if the command is a command for recording the setting data,
wherein the command for recording the setting data is received earlier than the commands for recording the image data and the adjustment data.

3. The head according to claim 2, wherein the data following the command for recording the setting data includes data for setting a pattern of the reference pulse waveform.

4. The head according to claim 1, wherein the setting data is data which causes the adjustment range of the adjustment data to be an integer multiple.

5. An image forming apparatus comprising:
an ink jet head; and
a control unit that causes an image corresponding to image data to be formed on a recording medium by ejecting ink drops from the ink jet head
wherein the ink jet head comprises:
a plurality of nozzles that eject ink drops through operations of corresponding driving elements;
an image storage unit that stores image data;
an adjustment storage unit that stores adjustment data which is set for each nozzle in order to uniformly correct variations in the ink drops ejected from the plurality of nozzles;
a setting storage unit that stores setting data for changing an adjustment range using the adjustment data;
a conversion unit that converts the adjustment data into adjustment effective data which is obtained by changing the adjustment range using the adjustment data on the basis of the setting data; and
a generation and output unit that generates a driving pulse waveform which is obtained by adjusting a reference pulse waveform of a driving pulse signal for operating the driving element by using the adjustment effective data on the basis of the image data for each nozzle, and applies the driving pulse signal with the driving pulse waveform to the driving element corresponding to each nozzle.
